(19) United States
(12) Patent Application Publication
(10) Pub. No.: US 2026/0192407 A1
(43) Pub. Date: Jul. 9, 2026

(54) METHODS AND DEVICES FOR POST MOULD PROCESSING OF A COMPOSITE STRUCTURE

(71) Applicant: LM Wind Power A/S, Kolding (DK)

(72) Inventors: Peter BROOME, Park Ridge, IL (US); John ARSENEAUX, New Orleans, LA (US); Murray FISHER, New Orleans, LA (US); Sierra VAN DIJK, New Orleans, LA (US); Matthew Joseph EMIG, New Orleans, LA (US)

(21) Appl. No.: 19/550,700

(22) Filed: Feb. 26, 2026

Related U.S. Application Data
(62) Division of application No. 18/038,618, filed on Nov. 26, 2021.

(30) Foreign Application Priority Data
Nov. 26, 2020 (GB) 2018606.0

(51) Int. Cl. B23Q 9/00; F03D 17/00; F03D 80/50

(52) U.S. Cl. CPC B23Q 9/0014; B23Q 9/0007; F03D 17/001; F03D 80/502; B23Q 2210/006; F05B 2230/80

(57) ABSTRACT

The present disclosure relates to methods and devices for post mould processing of a composite structure. The composite structure extends along a longitudinal direction and includes a main composite part, and a flange section extending around a perimeter of the main composite part. The flange section comprises an upper surface having a first mating part with a specific shape in a cross-sectional plane perpendicular to the longitudinal direction. The first mating part is located at a fixed position relative to the main composite part. In addition, an assistance tool defines a second mating part configured to fit with the specific shape of the first mating part of the flange section, such that, when the assistance tool is arranged on the flange section and the second mating part is fitted with the first mating part, the body of the assistance tool can be moved along the flange section at a pre-determined distance from the main composite part.

This application is a divisional application of U.S. application Ser. No. 18/038,618 filed May 24, 2023, which is a National Phase Application filed under 35 U.S.C. 371 as a national stage of PCT/EP2021/083134, filed Nov. 26, 2021, an application claiming the benefit of Great Britain Application No. 2018606.0, filed Nov. 26, 2020, the content of each of which is hereby incorporated by reference in its entirety.

The present disclosure relates to methods and devices for post mould processing of composite structures, such as wind turbine blades. Specifically, the present disclosure relates to a method for separating a flange section from a composite structure and/or a method for transferring one or more datum points on a composite structure and/or a method for inspection and/or processing of a surface area of an outer surface of a composite structure. Furthermore, the present disclosure relates to an assistance tool and a guiding device for use in the post mould processing of the composite structure.

### BACKGROUND

Wind power is considered one of the cleanest, most environmentally friendly energy sources presently available in the world today. A modern wind turbine typically includes a tower, a generator, a gearbox, a nacelle, and one or more rotor blades. The rotor blades capture kinetic energy of wind using known airfoil principles and transmit the kinetic energy in the form of rotational energy so as to turn a shaft coupling the rotor blades to a gearbox, or if a gearbox is not used, directly to the generator. The generator then converts the mechanical energy to electrical energy that may be deployed to a utility grid.

Wind turbine blades of fibre-reinforced polymer and in particular the aerodynamic shells of wind turbine blades are usually manufactured in moulds, where the pressure side and the suction side of the blade are manufactured separately by arranging glass fibre mats and/or other fibre-reinforcement material, such as carbon fibre, in each of the two mould parts. Afterwards, one of the two halves is turned upside down and positioned on top of the other of the two halves, and the two halves are glued together. The blade parts may be positioned on top of each other by turning and repositioning the complete half mould. It is known for manufacturers of wind turbine blades, when manufacturing blades in two halves, that it is necessary to secure and prevent the one blade shell part from falling out of the mould, during turning of the mould, such as when positioning the one blade shell part on top of the other. To prevent the blade shell part from falling out of the mould during turning and repositioning of the respective half mould, the blade shell parts are normally moulded with a flange section. The blade shells are fixed to the mould with a number of clamping tongs clamping the flange section to the mould and the blade shells can be turned upside down without falling out of the mould. When the shells have been glued together, the clamping tongs are removed, and the flange section is cut off manually in a process called flash trimming. Currently, there is a lack of template or engineering control for flash trimming of a blade. This may result in inconsistent trims, the need for further grinding, and the possibility of damage to the aerodynamic shape of the blade itself. Thus, it is of increasing interest to reduce the need for manual flash trimming and/or to provide tools and methods for assisting the manual flash trimming.

After assembly, the blade shells are normally surface treated. Such surface treatment may include removal of imperfections, by grinding, in the surface or appliance of layers of finishing to the surface. These processes are usually also performed manually, since efficient automatic or semi-automatic tools for assisting in surface treatment are lacking. Thus, surface treatment requires a lot of skills from the manufacturing crew and an uneven surface treatment may result in reduced quality. Thus, it would be advantageous to reduce the need for manual skills, streamline the process and increase the general product quality.

At present, undesirable quality issues are detected in the post production. Due to the deep curvature and steep tooling that accommodate the complex fibre lamination layers, a need for repairs of the wind turbine blades commonly occurs on or near the leading edge. This particular area is critical for establishing aerodynamic performance, annual electricity production yield, and the energy performance of the blade throughout its life. Blade repairs can be executed in many, many ways, from fully automated multiple robotic arms to handcrafted lamination and everything in between. In reality, throughout the industry, they are most commonly done by hand using handheld machines and composite lamination techniques, since the remaining existing tools are too complex and require too much engineering. Thus, it is of increasing interest to reduce the need for manual surface treatment and it would be advantageous to have a simple semi-automatic or automatic tool for surface treatment and repair of the blade after moulding, since such a solution might lead to reduction in manufacturing time and the requirement of skills, as well as improving quality during manufacturing.

### SUMMARY

It is an object of the present disclosure to provide methods and devices which overcome at least some of the disadvantages of the prior art.

Accordingly, a method for post mould processing of a composite structure is provided. The method may be a method for separating a flange section from a composite structure and/or a method for transferring one or more datum points on a composite structure and/or a method for inspection and/or processing of a surface area of an outer surface of a composite structure.

The composite structure extends along a longitudinal direction and comprises a main composite part, and a flange section extending around a perimeter of the main composite part. The flange section comprises an upper surface having a first mating part with a specific shape in a cross-sectional plane substantially perpendicular to the longitudinal direction, such as in a cross-sectional plane perpendicular to the perimeter of the main composite part. The first mating part is located at a fixed position relative to the main composite part. In preferred embodiments, the composite structure is a wind turbine blade, such as a wind turbine blade which is not yet finished. For example, the main composite part may be an airfoil of the wind turbine blade, and the flange section may extend from the main composite part along a leading edge and/or a trailing edge of the airfoil, or around the whole perimeter of the main composite part. The airfoil may comprise a first shell part arranged on top of a second shell part, wherein the first and second shell part are glued together along a bond line, e.g. along the leading edge and trailing edge. The first mating part may have a specific shape in a cross-sectional plane perpendicular to the trailing edge and/or leading edge of the wind turbine blade.

In some embodiments, the first mating part of the flange section in the cross-sectional plane perpendicular to the longitudinal direction comprises a first substantially linear section extending from the main composite part in a first direction, a first primary mating section extending from the first substantially linear section in a direction, which is different from the first direction, and optionally a first end section, extending from the first primary mating section in the first direction. However, a plurality of other shapes of the first mating part would also work within the scope of the present disclosure.

An assistance tool is also disclosed. The method for post mould processing of a composite structure may comprise providing an assistance tool, such as the disclosed assistance tool. For example, the assistance tool may be an assistance tool for assisting in tasks performed at the composite structure.

The assistance tool comprises a body having a bottom surface defining a second mating part shaped and dimensioned to fit with the specific shape of the first mating part of the flange section, such that when the assistance tool is arranged on the flange section and the second mating part is fitted with the first mating part, the body of the assistance tool can be moved along the flange section at a pre-determined distance from the main composite part.

The assistance tool may be configured to be arranged on the flange section, such that at least part of a lower surface of the body of the assistance tool is fitted with at least part of the flange section. Such an arrangement may allow the assistance tool to be used for different purposes. A plurality of different configurations of the first and second mating part are possible, as long as the first and second mating parts can be fitted such that the assistance tool can be moved along the flange section at a pre-determined distance from the main composite part. For this purpose, the first and second mating part may be configured such that pressure can be applied in at least one direction, e.g. in a vertical direction, to press the second mating part towards the first mating part, without the second mating part moving further towards the first mating part. The first and second mating parts are considered fitted, even though they may not physically align along the entirety of the first and second mating parts. When a pressure is simultaneously applied in the longitudinal direction of the composite structure, the assistance tool is movable along the flange section at a pre-determined distance from the main composite part. This is advantageous in a plurality of situations, as will be described in more detail below.

In some embodiments, the assistance tool comprises a cutting element connected to the body and configured for cutting the composite structure along a cutting path defined between the main composite part and the flange section. For example, to separate the flange section from the main composite part. In embodiments where the main composite part is an airfoil of a wind turbine blade, particularly to separate the flange section from the main composite part along the trailing edge and/or leading edge.

In some embodiments, the second mating part in the cross-sectional plane comprises a second substantially linear section extending in a first direction. The second mating part may have a second primary mating section extending from the second substantially linear section in a direction which is different from the first direction. Furthermore, the second mating part optionally comprises a second end section extending from the second primary mating section.

In some embodiments, the second primary mating section is a slope or a curve or a linear section extending with an angle between 10-170 degrees, such as 15-150 degrees, such as 20 -120 degrees, such as 25-90 degrees, such as 30-70 degrees, such as 35-50 degrees from the second substantially linear section. For example, the direction of the second primary mating section may form an angle between 10-170 degrees, such as 15-150 degrees, such as 20 -120 degrees, such as 25-90 degrees, such as 30-70 degrees, such as 35-50 degrees with the first direction.

In some embodiments, the cutting element is a circular saw. Alternatively, the cutting element may be a jigsaw or a band saw.

In some embodiments, the position of the cutting element is adjustable relative to the body, such that the cutting element can be moved between a first position and a second position. For example, the body may comprise a track allowing the cutting element to move relative to the body, the track may define the first and second position. In some embodiments, when the cutting element is arranged in the first position, the cutting element is arranged above the bottom surface of the body, and when the cutting element is in the second position, at least part of the cutting element is arranged below the lower surface of the body.

In some embodiments, the assistance tool is configured to be manually operated, e.g. by applying a force to the assistance tool in a direction towards the first mating part (e.g. to ensure a continued fit of the second mating part in the first mating part), while moving the body of the assistance tool along the flange section with the second mating part fitted with the first mating part.

In some embodiments, the assistance tool comprises an operating handle connected to the body and configured to facilitate manual operation of the assistance tool.

In some embodiments, at least part of the bottom surface of the body comprises a low-friction material allowing it to be moved with low friction along the flange section. For example, the bottom surface of the body may be made of polyoxymethylene (POM).

In some embodiments, the assistance tool comprises a datum point indicator. The datum point indicator may be connected to the body at a reference point. The datum point indicator may be configured for marking one or more datum points on the main composite part, e.g. relative to a datum point on the flange section of the composite structure. Alternatively or additionally, the datum point indicator may be configured for marking one or more datum points on the main composite part relative to another datum point on the composite structure. The datum point indicator may be configured for marking the one or more datum points when the assistance tool is moved along the flange section.

Datum points are well defined points on the composite structure, such as a wind turbine blade. The datum point may help in the post-mould processing of composite structures, e.g. to enable identification of specific areas, which specifically on large and curved composite structures may be difficult without appropriate reference points. For example, in the wind turbine industry, datum points on the flange section may be well established and known. However, when the flange section is separated from the main composite part, these datum points are removed too. The assistance tool of the present disclosure can assist in transferring such datum points from the flange section to the main composite part, before the flange section is cut off in an easy and precise manner. Advantageously, the assistance tool may comprise both the datum point indicator and the cutting element, allowing transfer of datum points while separating the flange in a single operation.

In some embodiments, the datum point indicator is an elongated element being attached at a first end to the reference point and having a datum point marker at a second end, opposite the first end.

The assistance tool may be configured such that the distance from the reference point to a datum point on the flange section is known when the first and second mating parts are fitted and the assistance tool is arranged at a specific location relative to the datum point.

In some embodiments, the datum point marker is a flexible liner and/or a liner adjustable in at least one length direction.

In some embodiments, the elongated element comprises telescopic cylinders and the datum point marker at an outermost cylinder of the telescopic cylinders, wherein the telescopic cylinders can be moved in and out of each other to adjust the position of the datum point marker relative to the reference point.

In an embodiment where the datum point marker is adjustable, the datum points may be transferred following an established set of rules, which for example depends on a distance from an end of the composite structure.

A system comprising the assistance tool and the composite structure is also provided in the present disclosure.

The method may comprise arranging the assistance tool such that the first mating part of the composite structure and the second mating part of the assistance tool are fitted to each other.

The method may comprise moving the assistance tool along the flange section while marking one or more datum points on the main composite part with the datum point marker at a pre-determined distance from respective one or more datum points, e.g. on the flange section, and/or while operating the cutting element, to separate the flange section from the main composite part along the cutting path.

Operating the cutting element and marking the one or more datum points may be performed simultaneously while moving the assistance tool along the flange section. Alternatively, an assistance tool with a datum point indicator may be moved along the flange section while marking the one or more datum points, and another or the same assistance tool with a cutting element may subsequently be moved along the flange section while operating the cutting element to separate the flange section from the main composite part.

In some embodiments, the pre-determined distance is a constant distance. In some other embodiments, the pre-determined distance is varying with the position of the assistance tool along the longitudinal direction relative to the composite structure.

A guiding device is also disclosed. The method for post mould processing of a composite structure may comprise providing a guiding device, such as the disclosed guiding device. The guiding device may be a guiding device for inspection and/or processing of the surface area of the outer surface of the composite structure. For example, the guiding device may be for inspection and/or processing of a surface area of an outer surface of the main composite part of the composite structure.

The guiding device may comprise one or more elongated base elements, such as a plurality of elongated base elements, including a primary elongated base element adapted to be arranged on the outer surface of the composite structure.

The guiding device may comprise one or more attachment elements, such as a plurality of attachment elements, for detachably attaching the one or more elongated base elements to the composite structure.

The guiding device may comprise one or more displacement bars, such as a plurality of displacement bars, including a primary displacement bar and optionally a secondary displacement bar. The primary displacement bar and/or the secondary displacement bar may be movably attached to the primary elongated base element.

The guiding device may comprise a support element movably attached to the one or more displacement bars and displaceable along the longitudinal direction and perpendicular to the longitudinal direction relative to the primary elongated base element. The support element may be adapted to be fitted with a tool for inspecting and/or processing the surface area of the composite structure.

The one or more elongated base elements and/or the one or more displacement bars may be more than a certain length to allow attachment sufficiently removed from the inspection site. For example, the one or more elongated base elements may be more than 1 metre, such as more than 2 metres, such as more than 3 metres, such as more than 5 metres. The one or more displacement bars may be more than 1 metre, such as more than 2 metres, such as more than 3 metres, such as more than 5 metres.

In some embodiments, the one or more elongated base elements include a secondary elongated base element. The primary displacement bar and/or the secondary displacement bar may be movably attached to the secondary elongated base element. The primary displacement bar and/or the secondary displacement bar may be extending between the primary elongated base element and the secondary elongated base element. The support element may be arranged between the primary elongated base element and the secondary elongated base element. The primary elongated base element and the secondary elongated base element may be parallel. In some embodiments, the support element is arranged between the primary displacement bar and the secondary displacement bar.

In some embodiments, the primary elongated base element and/or the secondary elongated base element are adapted to be arranged parallel to the longitudinal direction of the composite structure.

In some embodiments, the primary elongated base element and/or the secondary elongated base element are adapted to be arranged perpendicular to the longitudinal direction of the composite structure.

In some embodiments, the one or more elongated base elements include a tertiary elongated base element and optionally a quaternary elongated base element. The tertiary elongated base element and optionally the quaternary elongated base element may be arranged substantially perpendicular to the primary elongated base element. For example, the tertiary elongated base element and optionally the quaternary elongated base element may be fixedly attached and/or rigidly coupled to the primary elongated base element.

The tertiary elongated base element and the quaternary elongated base element may be parallel. The tertiary elongated base element and/or the quaternary elongated base element may be adapted to be arranged perpendicular or parallel to the longitudinal direction of the composite structure.

In some embodiments, the tertiary elongated base element and optionally the quaternary elongated base element extend between the primary elongated base element and the secondary elongated base element. For example, such as to maintain a fixed distance between the primary elongated base element and the secondary elongated base element.

The primary displacement bar and/or the secondary displacement bar may be movably attached to the tertiary elongated base element and/or the quaternary elongated base element. The primary displacement bar and/or the secondary displacement bar may be extending between the tertiary elongated base element and the quaternary elongated base element. In some embodiments the primary displacement bar extends between the primary elongated base element and the secondary elongated base element, and the secondary displacement bar extends between the tertiary elongated base element and the quaternary elongated base element.

In some embodiments, the support element is arranged between the tertiary elongated base element and the quaternary elongated base element.

In some embodiments, a plurality of the one or more displacement bars, such as the primary displacement bar and the secondary displacement bar, are parallel.

In some embodiments, a plurality of the one or more displacement bars, such as the primary displacement bar and the secondary displacement bar, are perpendicular.

In some embodiments, the primary displacement bar and/or the secondary displacement bar are arranged substantially perpendicular to the primary elongated base element. In some embodiments, the primary displacement bar and/or the secondary displacement bar are arranged substantially perpendicular to the tertiary elongated base element.

In some embodiments, the primary displacement bar and/or the secondary displacement bar are movable along the primary elongated base element and/or along the secondary elongated base element. Alternatively or additionally, the primary displacement bar and/or the secondary displacement bar are movable along the tertiary elongated base element and/or along the quaternary elongated base element. For example, the primary displacement bar and/or the secondary displacement bar may be movable along the longitudinal direction and/or perpendicular to the longitudinal direction of the composite structure.

In some embodiments, the support element is movable along the one or more displacement bars.

In some embodiments, the primary displacement bar and/or the secondary displacement bar are curvilinear bars, e.g. adapted to substantially follow a curvature of the surface area of the composite structure.

In some embodiments, the primary displacement bar and/or the secondary displacement bar comprise a first end movably attached to the primary elongated base element and/or the tertiary elongated base element. The primary displacement bar and/or the secondary displacement bar may comprise a second end, opposite the first end, adapted to contact and being slidable over the outer surface of the composite structure. For example, the primary displacement bar and/or the secondary displacement bar may comprise a wheel arranged at the second end adapted to contact the outer surface of the composite structure.

In some embodiments, each of the one or more attachment elements comprises a vacuum element with a fluid outlet adapted to be connected to a vacuum source. The vacuum source may be a pump. The vacuum element may be adapted to adhere to the outer surface of the composite structure, e.g. by application of a negative pressure by the vacuum source.

In some embodiments, one or more of the one or more attachment elements, such as a primary attachment element and/or a plurality of primary attachment elements of the one or more attachment elements are arranged on the primary elongated base element, such as to be positioned between the primary elongated base element and the outer surface of the composite structure.

In some embodiments, one or more of the one or more attachment elements, such as a tertiary attachment element and/or a plurality of primary attachment elements of the one or more attachment elements are arranged on the tertiary elongated base element, such as to be positioned between the tertiary elongated base element and the outer surface of the composite structure.

The method may comprise attaching the guiding device to the outer surface of the composite structure, e.g. aligning the one or more elongated base elements of the guiding device with the one or more datum points on the main composite part. Attaching the guiding device may be performed after moving the assistance tool along the flange section while marking one or more datum points and/or separating the flange section from the main composite part.

In some embodiments, the one or more datum points are located outside the surface area of the composite structure.

In some embodiments, the surface area includes a part of the leading edge of the wind turbine blade.

In some embodiments, the one or more datum points are positioned more than a first distance from the leading edge of the wind turbine blade.

The method may comprise fitting the support element with a tool for inspecting and/or processing a surface area of the composite structure.

The tool for inspecting and/or processing a surface area of the composite structure may for example be a spray gun for applying finisher, an element for evening out finisher applied by other means or a grinder for evening out the surface or excavating an area to be repaired.

The method may comprise moving the support element to be above the surface area.

The method may comprise inspecting and/or processing the surface area with the tool.

### BRIEF DESCRIPTION OF THE FIGURES

Embodiments of the disclosure will be described in more detail in the following with regard to the accompanying figures. The figures show one way of implementing the present invention and are not to be construed as being limiting to other possible embodiments falling within the scope of the attached claim set.

FIG. 1 illustrates a conventional modern upwind wind turbine,

FIG. 2 shows a schematic view of an exemplary wind turbine blade,

FIG. 3 is a schematic diagram illustrating an exemplary mould system,

FIGS. 4A-4C are schematic diagrams illustrating an exemplary mould system for an exemplary composite structure,

FIGS. 5A-5B are schematic diagrams illustrating an exemplary assistance tool being arranged on an exemplary flange section of a composite structure,

FIGS. 6A-6B are schematic diagrams illustrating an exemplary assistance tool being arranged on an exemplary flange section of a composite structure,

FIGS. 7A-7E are schematic diagrams illustrating first and second mating parts of an assistance tool and a flange section, respectively,

FIGS. 8A-8D are schematic diagrams illustrating an exemplary assistance tool comprising a cutting element for separating a flange section from a main composite part of a composite structure,

FIGS. 9A-9C are schematic diagrams illustrating an exemplary assistance tool and part of an exemplary composite structure,

FIGS. 10A-10B are schematic diagrams illustrating an exemplary assistance tool comprising a datum point indicator, and part of an exemplary composite structure,

FIGS. 11A-11B are schematic diagrams illustrating an exemplary assistance tool comprising a datum point indicator that can be adjusted in two directions and part of an exemplary composite structure,

FIG. 12 is a schematic diagram illustrating an exemplary assistance tool comprising a flexible datum point indicator and part of an exemplary composite structure,

FIGS. 13A-13C are schematic diagrams illustrating an exemplary guiding device attached to an exemplary composite structure,

FIGS. 14A-14C are schematic diagrams illustrating an exemplary guiding device attached to an exemplary composite structure,

FIG. 15 is a flow-chart of a method for post mould processing of a composite structure,

FIG. 16 is a flow-chart of a method for post mould processing of a composite structure, and

FIG. 17 is a flow-chart of a method for post mould processing of a composite structure.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiment even if not so illustrated, or if not so explicitly described.

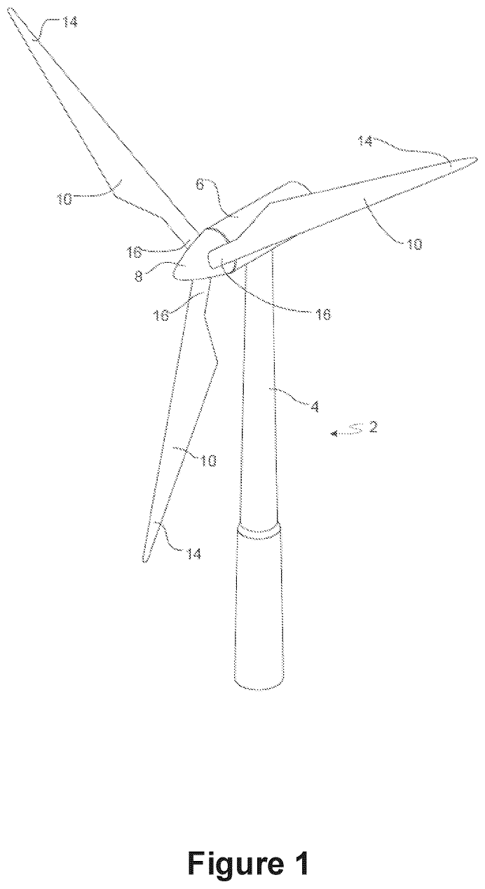

FIG. 1 illustrates a conventional modern upwind wind turbine 2 according to the so-called “Danish concept” with a tower 4, a nacelle 6 and a rotor with a substantially horizontal rotor shaft. The rotor includes a hub 8 and three blades 10 extending radially from the hub 8, each having a blade root 16 nearest the hub and a blade tip 14 furthest from the hub 8.

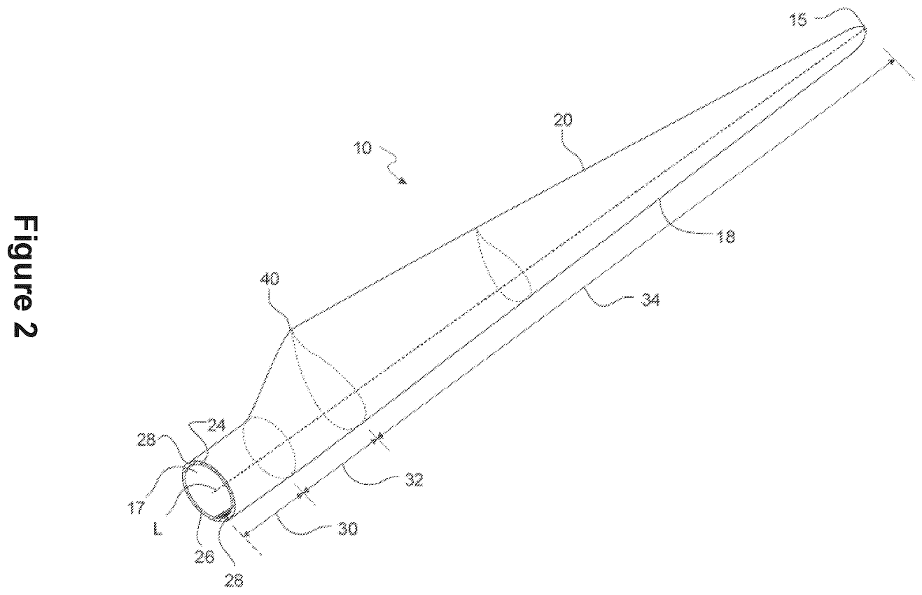

FIG. 2 shows a schematic view of an exemplary wind turbine blade 10. The wind turbine blade 10 has the shape of a conventional wind turbine blade with a root end 17 and a tip end 15 and comprises a root region 30 closest to the hub, a profiled or an airfoil region 34 furthest away from the hub and a transition region 32 between the root region 30 and the airfoil region 34. The blade 10 comprises a leading edge 18 facing the direction of rotation of the blade 10, when the blade is mounted on the hub, and a trailing edge 20 facing the opposite direction of the leading edge 18.

The airfoil region 34 (also called the profiled region) has an ideal or almost ideal blade shape with respect to generating lift, whereas the root region 30 due to structural considerations has a substantially circular or elliptical cross-section, which for instance makes it easier and safer to mount the blade 10 to the hub. The diameter (or the chord) of the root region 30 may be constant along the entire root area 30. The transition region 32 has a transitional profile gradually changing from the circular or elliptical shape of the root region 30 to the airfoil profile of the airfoil region 34. The chord length of the transition region 32 typically increases with increasing distance r from the hub. The airfoil region 34 has an airfoil profile with a chord extending between the leading edge 18 and the trailing edge 20 of the blade 10. The width of the chord decreases with increasing distance r from the hub.

A shoulder 40 of the blade 10 is defined as the position, where the blade 10 has its largest chord length. The shoulder 40 is typically provided at the boundary between the transition region 32 and the airfoil region 34.

It should be noted that the chords of different sections of the blade normally do not lie in a common plane, since the blade may be twisted and/or curved (i.e. pre-bent), thus providing the chord plane with a correspondingly twisted and/or curved course, this being most often the case in order to compensate for the local velocity of the blade being dependent on the radius from the hub.

The wind turbine blade 10 comprises a blade shell comprising two blade shell parts or half shells, a first blade shell part 24 and a second blade shell part 26, typically made of fibre-reinforced polymer. The wind turbine blade 10 may comprise additional shell parts, such as a third shell part and/or a fourth shell part. The first blade shell part 24 is typically a pressure side or upwind blade shell part. The second blade shell part 26 is typically a suction side or downwind blade shell part. The first blade shell part 24 and the second blade shell part 26 are fastened together with adhesive, such as glue, along bond lines or glue joints 28 extending along the trailing edge 20 and the leading edge 18 of the blade 10. Typically, the root ends of the blade shell parts 24, 26 have a semi-circular or semi-oval outer cross-sectional shape.

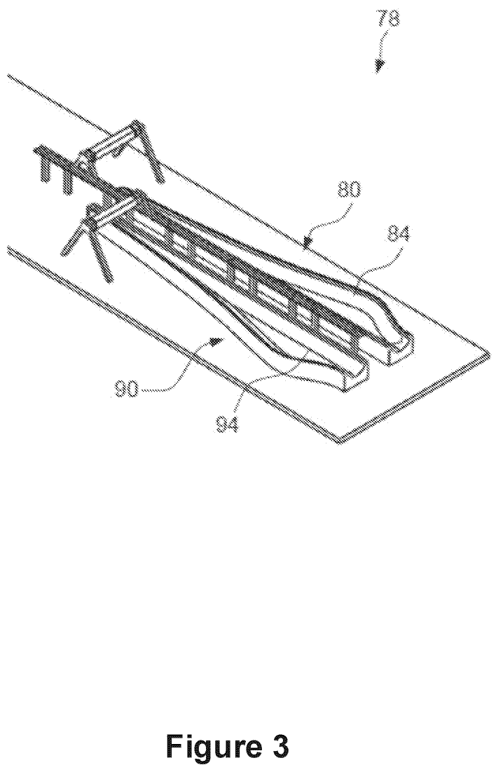

FIG. 3 is a schematic diagram illustrating an exemplary mould system 78 for moulding a blade shell of a wind turbine blade. The mould system 78 comprises a first mould 80 and a second mould 90. The first mould 80 is configured for manufacturing a first blade shell part of a wind turbine blade, such as an upwind shell part of the wind turbine blade. The second mould 90 is configured for manufacturing a second blade shell part of the wind turbine blade, such as a downwind shell part of the wind turbine blade.

The first mould 80 has a first moulding surface 84. The second mould 90 has a second moulding surface 94. The first and second moulding surfaces 84, 94 are configured for defining an outer shape of the blade shell parts.

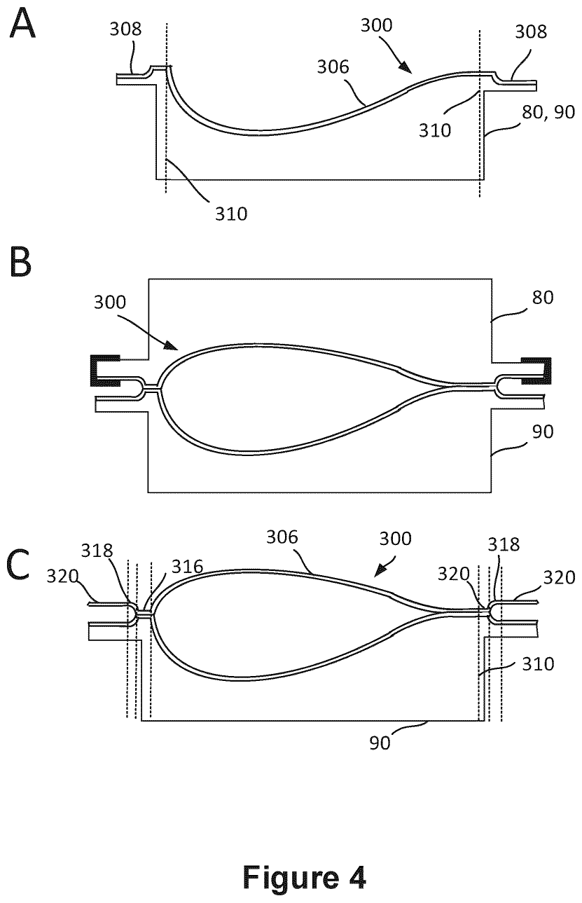

FIG. 4A is a schematic diagram illustrating a cross-sectional view in a longitudinal direction of an exemplary mould 80, 90, such as the first mould 80 or the second mould 90 of FIG. 3. Part of a composite structure 300, such as a blade half shell of a wind turbine blade, is formed in the mould 80, 90, e.g. by laying-up fibre material on the moulding surface and subsequently infusing the fibres with resin, and curing the resin. The composite structure 300 comprises a main composite part 306 i.e. the curved shape of the composite structure 300 which is to be part of the finished wind turbine blade.

Many wind turbine blade moulds are made with a flange section 308 extending around a perimeter of each shell part of the mould. The purpose of having the flange section 308 is to facilitate assembly of the shell parts, e.g. in securing the blade part in the mould when lifting and turning the mould. However, the flange section 308 will be cut off before the end of the manufacturing process. Thus, in a certain phase of the manufacturing process, each shell part comprises a main composite part 306, i.e. the part that will be part of the finished wind turbine, and a flange section 308 which is used when assembling the two shell parts.

Thus, the composite structure 300 comprises a flange section 308 extending around the perimeter of the main composite part 306. When the flange section 308 has served its purpose, it is to be cut off along the cutting path 310. The cutting path 310 is illustrated by a dotted line.

FIG. 4B is a schematic diagram illustrating a cross-sectional view of two moulds 80, 90 arranged on top of each other and each comprising a respective part of the composite structure 300 as described in relation to FIG. 4A. The part of the composite structure 300 layed-up in the first mould 80 is kept in place by two clamps, holding the first end section 320 of the flange section 308 and the first mould together when the mould is turned upside-down.

FIG. 4C is a schematic diagram illustrating a cross-sectional view of the composite structure 300 after assembly of the two shell halves, when the first mould is removed, but before the flange section 308 is cut off and where the wind turbine blade is ready to be post mould processed.

In this state, an assistance tool, which will be described in further detail below, can be arranged on the flange section 308 to assist in post mould processing. The assistance tool may utilize the flange section 308 in an advantageous way, allowing it to assist in different tasks performed at the wind turbine blade.

In FIG. 4C, the specific shape of the first mating part 314 i.e. an upper surface of the flange section 308 in the cross-sectional plane perpendicular to a longitudinal direction of the composite structure 300, comprises a first linear section 316 extending from the main composite part 306 in a first direction, a first primary mating section 318, which is a slope extending from the first substantially linear section in a direction which is different from the first direction, and a first end section 320 extending from the first primary mating section 318 in the first direction. The dotted lines in FIG. 4C illustrate the separation of the different sections of the first mating part 314 of the flange section.

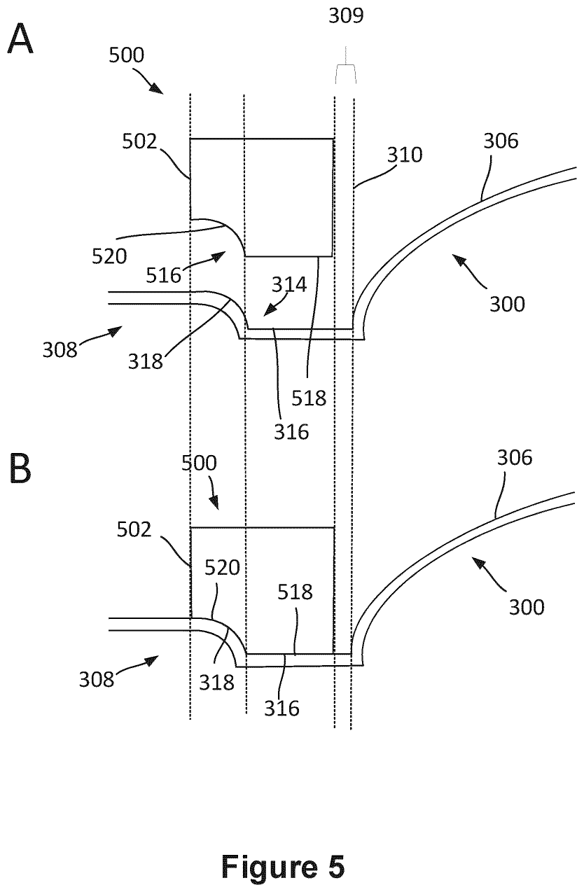

FIGS. 5A and 5B are schematic diagrams illustrating a cross-sectional view of an embodiment of an assistance tool 500 according to the present disclosure and a composite structure 300, such as a wind turbine blade, comprising a flange section 308 and a main composite part 306.

As illustrated in FIG. 5B, the assistance tool 500 of the present invention is configured to be arranged on the flange section 308, such that at least part of a lower surface of a body 502 of the assistance tool 500 is fitted with at least part of the flange section 308 in a specific arrangement that allows the assistance tool 500 to be used for its intended purposes in a precise position relative to the composite structure 300.

In FIG. 5A, the assistance tool 500 is shown separated from the flange section 308 of the composite structure 300, e.g. prior to being arranged on the flange section 308, as illustrated in FIG. 5B.

The flange section 308 of the composite structure 300 comprises an upper surface having a specific shape in a cross-sectional plane perpendicular to the longitudinal direction of the composite structure 300. At least part of the upper surface of the flange section 308 is configured to be fitted with a lower surface of the assistance tool 500 of the present invention. The part of the flange section 308 configured to be fitted with the assistance tool 500 is herein denoted as the first mating part 314. The part of the bottom surface of the assistance tool 500 configured to be fitted with the flange section 308 is herein referred to as the second mating part 516 of the assistance tool 500. The first mating part 314 and the second mating part 516 are configured such that when the assistance tool 500 is arranged on the flange section 308 and the second mating part 516 is fitted with the first mating part 314, the body 502 of the assistance tool 500 can be moved along the flange section 308 at a pre-determined distance 309 from the main composite part 306, i.e. the part of the composite structure that will be present in the finished composite structure.

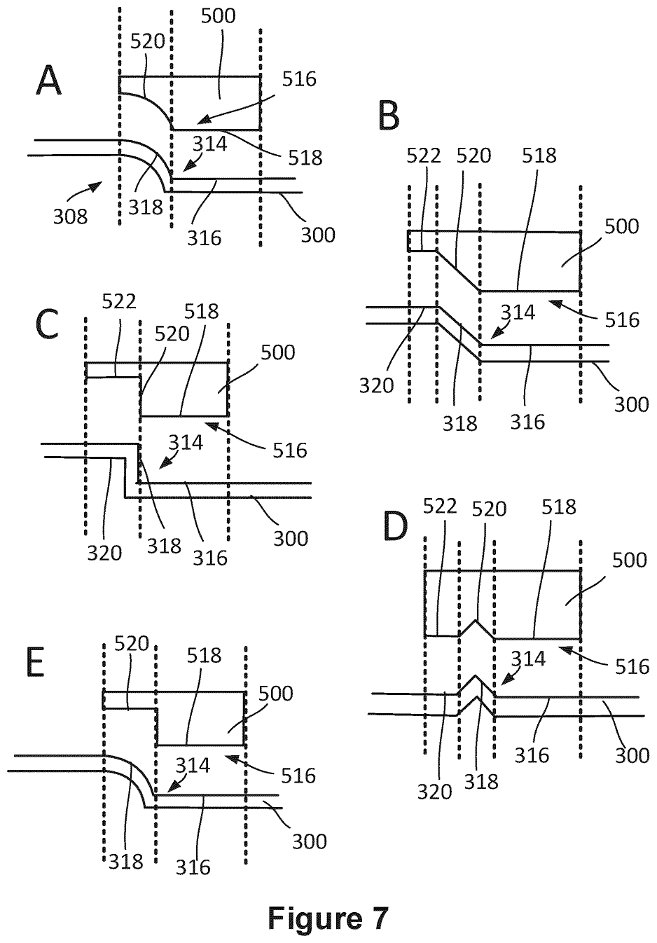

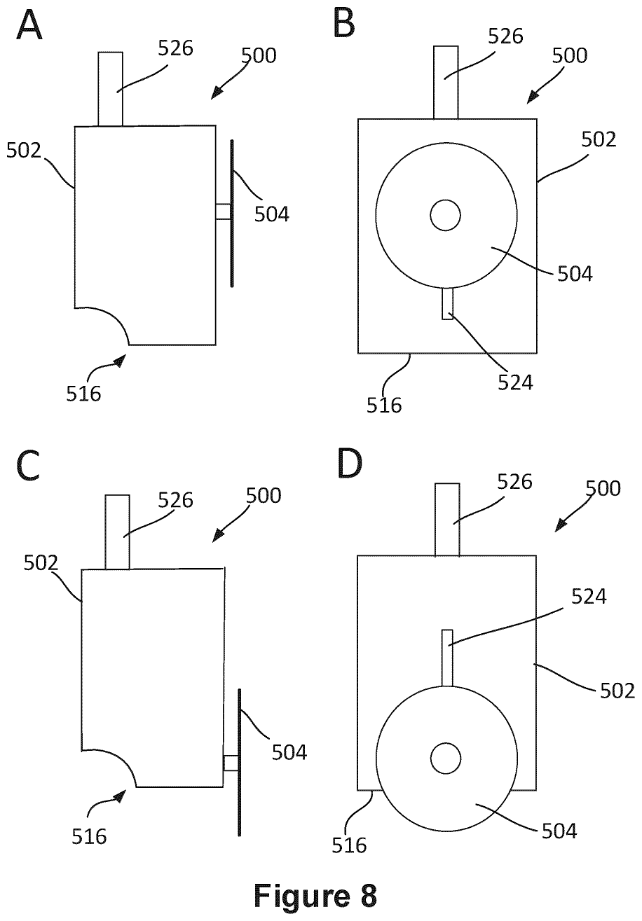

In FIGS. 5A and 5B, the first mating part 314 comprises a first substantially linear section and a curved first primary mating section 318 extending from the first substantially linear section in a direction. In the same way, the second mating part 516 comprises a second substantially linear section 518 and a curved second primary mating section 520 extending from the second substantially linear section 316. A plurality of alternative configurations of the first mating part 314 and the second mating part 516 are possible, provided the first mating part 314 and the second mating part 516 can be fitted such that the assistance tool 500 can be moved along the flange section 308 at a pre-determined distance 309 from the main composite part 306 (some alternatives are exemplified in FIGS. 7A-7E). For this purpose, the first mating part 314 and the second mating part 516 may advantageously be configured such that pressure can be applied in at least one direction to press the second mating part 516 towards the first mating part 314. The first mating part 314 and the second mating part 516 may be considered fitted, even though they may not physically fit along the entire of the first and second mating parts 314, 516, e.g. when the second mating part 516 does not move further towards the first mating part 314 upon application of pressure to press the second mating part 516 towards the first mating part 314. When a pressure is applied in the longitudinal direction of the composite structure 300 simultaneously with a pressure towards the first mating part 314, the assistance tool 500 should be able to be moved along the flange section 308, at a pre-determined distance 309 from the main composite part 306. This is advantageous in a plurality of situations. For example, such as in the embodiments described in relation to FIGS. 8-12.

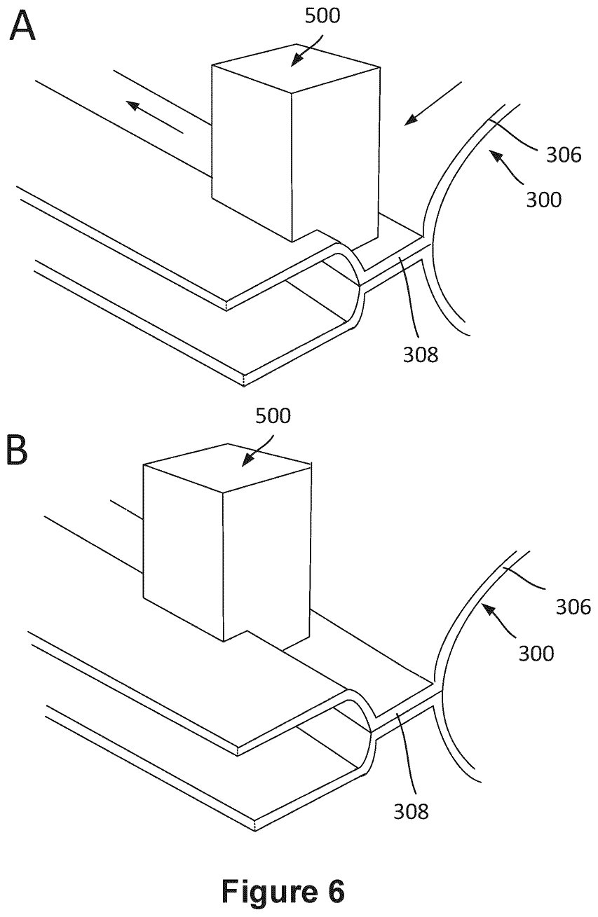

FIGS. 6A and 6B are schematic illustrations showing a three-dimensional view of an exemplary assistance tool 500, such as the assistance tool described in relation to FIGS. 5A and 5B. The assistance tool is arranged on a flange section 308, wherein a force (arrows) is applied to the assistance tool 500 towards the first mating part 314 of the flange section 308, as well as in a longitudinal direction of the main composite part 306, thereby moving the assistance tool 500 along the main composite part 306 at a fixed position relative to the main composite part 306.

FIGS. 7A-7E illustrate five exemplary configurations for the first and second mating parts 314, 516, as described in relation to the previous figures. The dotted lines illustrate the different sections of the first and second mating parts 314, 516.

In FIG. 7A, the first mating part 314, i.e. at least part of an upper surface of the flange section 308, comprises a first linear section 316 extending in a first direction and a curved first primary mating section 318 extending from the first linear section 316 in a direction which is different from the first direction. The second mating part 516, i.e. the bottom of the body 502 of the assistance tool 500, comprises a second linear section 518 and a curved second primary mating section 520 extending from the second linear section 518 in a direction which is different from the first direction. The first and second mating parts 314, 516 are configured such that the first and second mating parts 314, 516 can be fitted as described in the previous section.

In FIG. 7B, the first mating part 314 comprises a first linear section 316 extending in a first direction and a linear first primary mating section 318 extending from the first linear section 316 in a direction which is different from the first direction, e.g. a 45 degrees angle relative to the first linear section 316. The first mating part 314 further comprises a linear end section 320 extending from the first primary mating section 318 in the first direction. The second mating part 516 comprises a second linear section 518 and a second linear primary mating section 520 extending from the second linear section 518 in a direction, which is different from the first direction, e.g. a 45 degrees angle relative to the second linear section 518. Furthermore, the second mating part 516 comprises a linear end section 522 extending from the first primary mating section 520 in the first direction. Again, the first and second mating parts 314, 516 are configured such that the first and second mating parts 314, 516 can be fitted as described above.

In FIG. 7C, the first mating part 314 comprises a first linear section 316 extending in a first direction and a linear first primary mating section 318 extending from the first linear section 316 in a direction which is different from the first direction, e.g. a 90 degrees angle relative to the first linear section 316. The first mating part 314 further comprises a linear end section 320 extending from the first primary mating section 318 in the first direction. The second mating part 516 comprises a second linear section 518 and a second linear primary mating section extending from the second linear section 518 in a direction which is different from the first direction, e.g. a 90 degrees angle relative to the second linear section 518, and a second end section 522 extending from the second primary mating section 520 in the first direction. The first and second mating parts 314, 516 are configured such that the first and second mating parts 314, 516 can be fitted as described above.

In FIG. 7D, the first mating part 314 comprises a first linear section 316 extending in a first direction and a first primary mating section 318 comprising a primary part extending from the first linear section 316 in a primary direction which is different from the first direction, e.g. a 45 degrees angle relative to the first linear section 316. The first primary mating section 318 further comprises a secondary part extending from the primary part in a secondary direction which is different from the primary direction and the first direction, e.g. a 45 degrees angle relative to the first linear section 316 and/or a 90 degrees angle relative to the primary direction. Thus, the first primary mating section 318 forms a protrusion like structure. The first mating part 314 further comprises a linear end section 320 extending from the first primary mating section 318 in the first direction. The second mating part 516 comprises a second linear section 518 extending in a first direction and a second primary mating section 520 comprising a primary part extending from the second linear section 518 in a primary direction which is different from the first direction, e.g. a 45 degrees angle relative to the second linear section 518. The second primary mating section 520 further comprises a secondary part extending from the primary part in a secondary direction which is different from the primary direction and the first direction, e.g. a 45 degrees angle relative to the second linear section 518 and/or a 90 degrees angle relative to the primary direction. Thus, the second primary mating section 520 forms an indentation like structure configured to engage with the protrusion like structure of the first primary mating section 318. The second mating part further comprises a linear end section 522 extending from the second primary mating section 520 in the first direction. The first and second mating parts 314, 516 are configured such that the first and second mating parts 314, 516 can be fitted as described above.

In FIG. 7E, the first mating part 314 comprises a first linear section 316 extending in a first direction and a curved first primary mating section 318 extending from the first linear section 316, i.e. the first mating part 314 is substantially as illustrated and described in relation to FIG. 7A. The second mating part 516 comprises a second linear section 518 and a second linear primary mating section extending from the second linear section 518 in a direction which is different from the first direction, e.g. a 90 degrees angle relative to the second linear section 518, and a second end section 522 extending from the second primary mating section 520 in the first direction, i.e. the second mating part 516 is substantially as illustrated and described in relation to FIG. 7C. Notably, in FIG. 7E, the first and second mating parts 314, 516 do not have the same shape as in FIGS. 7A-7D. However, when fitted, the first and second mating parts 314, 516 are configured such that a pressure can be applied in at least one direction to press the second mating part 516 towards the first mating part 314 to fit the second mating part 516 and the first mating part 314. Thus, the first and second mating parts 314, 516 are considered fitted, even though they do not physically fit along the entirety of the first and second mating parts 314, 516, and the assistance tool 500 can be moved along the flange section at a pre-determined distance from the main composite part.

FIGS. 8A-8D are schematic illustrations of an exemplary assistance tool 500 according to the present disclosure, such as the assistance tool 500 as described in relation to previous figures. FIGS. 8A and 8C are side views of two different configurations of the assistance tool, and FIGS. 8B and 8D are front views of the configurations of FIGS. 8A and 8C, respectively.

The assistance tool 500 in FIGS. 8A-8D comprises a body 502 having a bottom surface defining a second mating part 516 configured to be fitted with the first mating part 314 of the flange section. Furthermore, the assistance tool 500, as illustrated, comprises a cutting element 504. In the exemplified case, the cutting element 504 is a circular saw. The cutting element 504 is arranged at a pre-determined distance from the body 502 and configured for separating the flange section 308 from the main composite part 306 of the composite structure 300, as described in relation to the previous figures, e.g. FIGS. 5A and 5B. For example, the cutting element is arranged at the pre-determined distance 309, as illustrated in FIG. 5A, from the body 502, such as to separate the flange section 308 from the main composite part 306 along the cutting path 310.

The position of the cutting element 504 relative to the body 502 of the assistance tool 500 may be adjustable, such that the cutting element 504 can be moved between a first position, as illustrated in FIGS. 8A and 8B, and a second position, as illustrated in FIGS. 8C and 8D. The body 502 comprises a track 524 allowing the cutting element 504 to move relative to the body 502, the track 524 defining the first and second position. When the cutting element 504 is arranged in the first position (FIGS. 8A and 8B), the cutting element 504 is arranged above the bottom surface of the body 502 and is not configured to cut. When the cutting element 504 is in the second position (FIGS. 8C and 8D), at least part of the cutting element 504 is arranged below the lower surface of the body 502 and the cutting element 504 is configured to cut into the flange section 308 of the composite structure 300.

The assistance tool 500, as illustrated in FIGS. 8A-8D, further comprises an operating handle 526 connected to the body 502 and configured to facilitate manual operation of the assistance tool 500, e.g. movement of the assistance tool 500 along the flange section 308 of the composite structure 300 when the first mating part 314 of the flange section 308 is fitted with the second mating part 516 of the assistance tool 500, by applying a force to the assistance tool 500 in a direction towards the first mating part 314 and a force in a longitudinal direction of the composite structure 300.

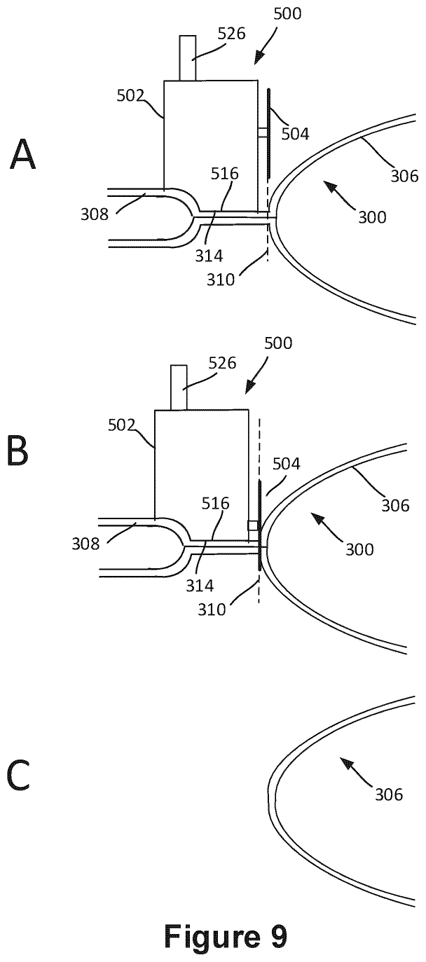

FIGS. 9A-9C illustrate the assistance tool 500 described in relation to FIGS. 8A-8D, cutting off a flange section 308 of a composite structure 300. The composite structure 300 may be a wind turbine blade and comprises a main composite part 306 and a flange section 308. The flange section 308 has an upper surface comprising a first mating part 314. The first mating part 314 is the part of the flange section 308 in contact with the second mating part 516 of the assistance tool 500, i.e. the bottom part of the body 502 of the assistance tool 500.

In FIG. 9A, the cutting element 504 is arranged in the first position. In FIG. 9B, the cutting element 504 is arranged in the second position and separating the main composite part 306 from the flange section 308 of the composite structure 300 along the cutting path 310. In FIG. 9C, the flange section 308 has been separated from the main composite part 306 by movement of the assistance tool along the flange section 308 while operating the cutting element 504, leaving the main composite part 306 ready for further processing. Because the flange section 308 and the assistance tool 500 are well established, the position of the cutting element 504 relative to the main composite part 306 can be determined and maintained, such that it can be moved along a cutting path defined between the flange section 308 and the main composite part 306, thereby reducing the need of skills from the manufacturing crew to remove the flange section 308 in a precise manner.

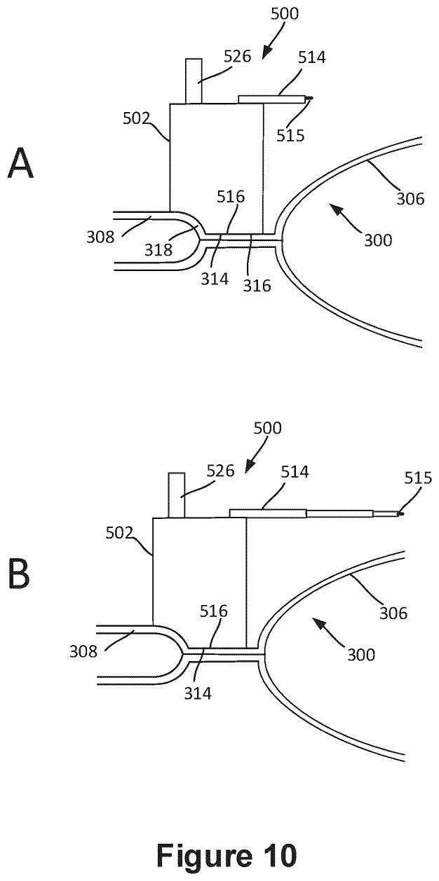

FIGS. 10A and 10B are schematic illustrations similar to that of FIGS. 9A and 9B. However, instead of comprising a cutting element 504 as in FIGS. 9A and 9B, the assistance tool 500 comprises a datum point indicator 514 connected to the body 502 at a reference point and configured for marking one or more datum points on the main composite part 306 relative to a datum point on the flange section 308 of the composite structure 300, when the assistance tool 500 is moved along the flange section 308. For example, the interface between the first linear section 316 and the first primary mating section 318 may be a well-established datum point of the composite structure. Hence, when the second mating part 516 is arranged and fitted with the first mating part 314 of the flange section 308, the position of the datum point indicator 514 relative to the datum point of the flange section 308 is known, and a corresponding datum point may be indicated on the main composite part 306.

In FIGS. 10A and 10B, the datum point indicator 514 is an elongated element being attached at a first end to the reference point and having a datum point marker 515 at a second end, opposite the first end. The assistance tool 500 is configured such that the distance from the reference point to a datum point on the flange section 308, e.g. the interface between the first linear section 316 and the first primary mating section 318, is known, when the first and second mating parts 314, 516 are fitted. By knowing the distance from the point of the assistance tool 500 arranged at the datum point to the reference point, a new datum point with a known location relative to the known datum point can be marked on the main composite part 306 of the composite structure 300.

The datum point indicator 514 in FIGS. 10A and 10B is adjustable in one length direction and the elongated element comprises telescopic cylinders which can be moved in and out of each other to elongate the datum point marker 515 until it reaches the main composite part 306. The datum point marker 515 is arranged at an outermost cylinder of the telescopic cylinders.

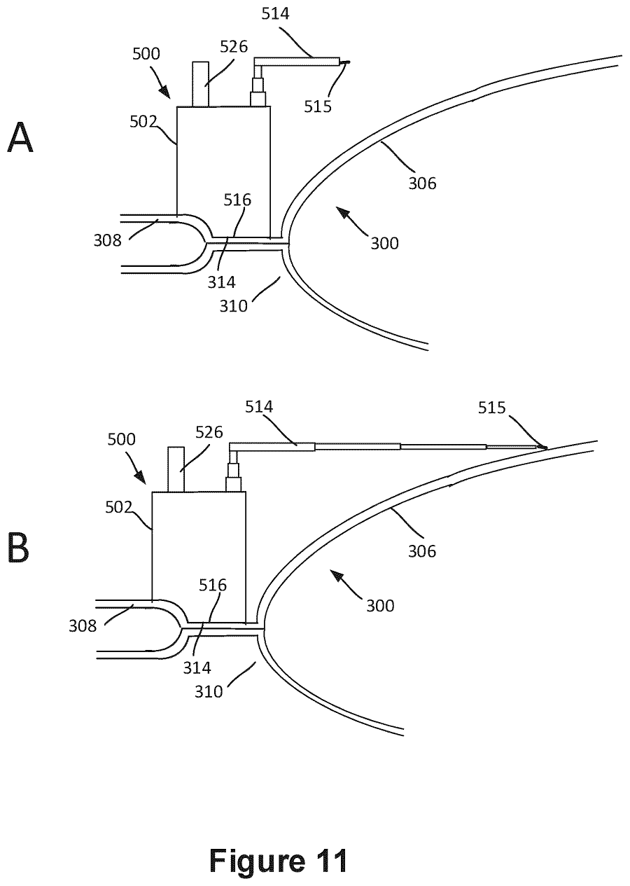

FIGS. 11A and 11B are schematic illustrations of another embodiment of a datum point indicator 514 similar to that of FIG. 10. However, instead of comprising one set of telescopic cylinder and being adjustable in only one direction, the datum point indicator 514 comprises two sets of telescopic cylinders and is adjustable in two directions, such that the height of the new datum point relative to the known datum point can be determined and varied as desired. To obtain a useful datum point indication on the main composite part 306 the datum point indicator 514 is either locked in a known position, or is varied according to a known process, e.g. depending on a position along the length of the composite structure.

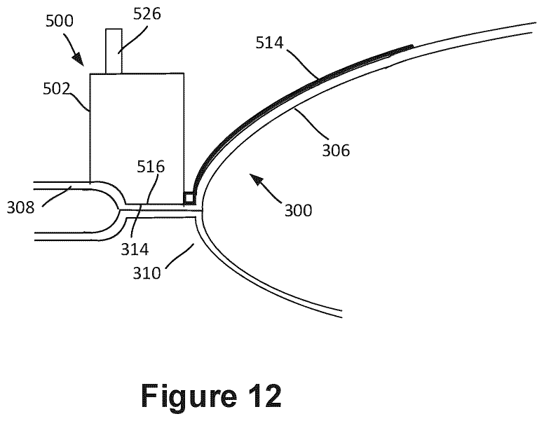

FIG. 12 is a schematic illustration of another embodiment of a datum point indicator 514 where a flexible liner with a fixed length is attached to a reference point on the body 502 of the assistance tool 500 and can be arranged along the curvature of the main composite part for transferring a datum point. Since the liner is flexible, it should be manually placed for each datum point transfer.

It is noted that the assistance tool 500 may comprise both the cutting element 504, as illustrated in FIGS. 8-9, and the datum point indicator 514, as illustrated in FIGS. 10-12. Thereby allowing simultaneous cutting and transferring datum points.

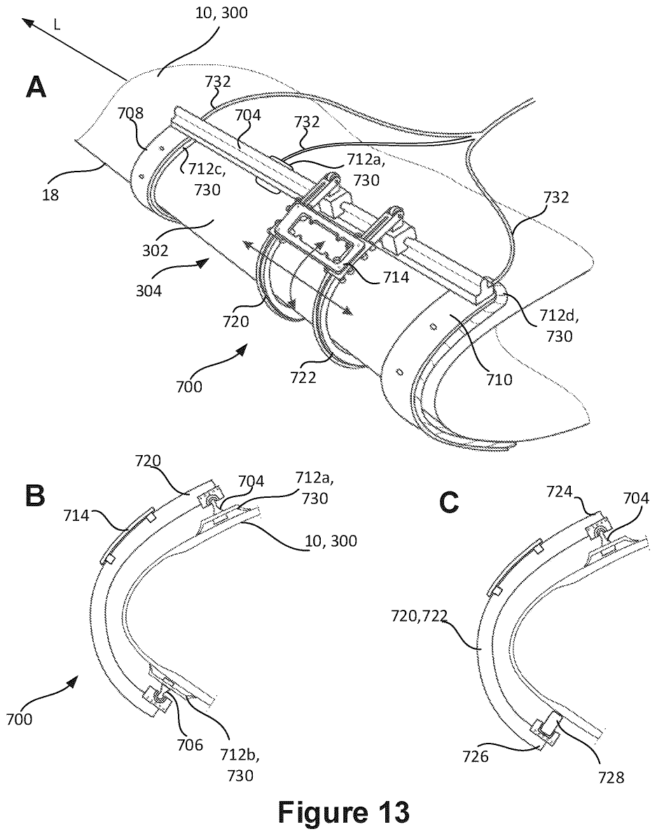

FIG. 13A is a schematic illustration of a three-dimensional view of an exemplary guiding device 700 fitted on an exemplary composite structure 300, such as a wind turbine blade 10. In the illustrated example, a portion near the leading edge 18 of the wind turbine blade 10 fitted with the guiding device 700 is shown. The guiding device 700 is configured for inspection and/or processing of a surface area 304 of an outer surface 302 of the composite structure. The composite structure 300 extends along a longitudinal direction L.

FIG. 13B is a schematic illustration of a cross-sectional view of the exemplary guiding device 700 and composite structure 300 of FIG. 13A.

The guiding device 700 comprises one or more elongated base elements. In the illustrated example, the guiding device comprises a primary elongated base element 704, a secondary elongated base element 706, a tertiary elongated base element 708 and a quaternary elongated base element 710. The primary elongated base element 704 and the secondary elongated base element 706 may be parallel. The tertiary elongated base element 708 and the quaternary elongated base element 710 may be parallel. The tertiary elongated base element 708 and the quaternary elongated base element 710 may be arranged substantially perpendicular to the primary elongated base element 702 and the secondary elongated base element 704.

The elongated base elements 704, 706, 708, 710 are adapted to be arranged on the outer surface of the composite structure 300. The tertiary elongated base element 708 and the quaternary elongated base element 710 may extend between the primary elongated base element 704 and the secondary elongated base element 706. The elongated base elements 704, 706, 708, 710 may be arranged parallel and/or perpendicular to the longitudinal direction L of the composite structure 300. For example, as illustrated, the primary elongated base element 704 and the secondary elongated base element 706 may be arranged parallel to the longitudinal direction L, and the tertiary elongated base element 708 and the quaternary elongated base element 710 may be arranged perpendicular to the longitudinal direction L. In an alternative embodiment the primary elongated base element 704 and the secondary elongated base element 706 may be arranged perpendicular to the longitudinal direction L.

The guiding device 700 comprises one or more attachment elements 712a, 712b, 712c, 712d for detachably attaching the elongated base elements 704, 706, 708, 710 to the composite structure 300. Each of the attachment elements 712a, 712b, 712c, 712d may comprise a vacuum element 730 with a fluid outlet 732 adapted to be connected to a vacuum source, such as to be adapted to adhere to the outer surface 302 of the composite structure 300 by application of a negative pressure by the vacuum source.

In the illustrated example, the guiding device comprises a primary attachment element 712a, a secondary attachment element 712b, a tertiary attachment element 712c and a quaternary attachment element 712d. In other embodiments, the guiding device may comprise only the tertiary attachment element 712c and the quaternary attachment element 712d or only the primary attachment element 712a and the secondary attachment element 712b.

The primary attachment element 712a is arranged on the primary elongated base element 704, such as to be positioned between the primary elongated base element 704 and the outer surface 302 of the composite structure 300. The secondary attachment element 712b is arranged on the secondary elongated base element 706, such as to be positioned between the secondary elongated base element 706 and the outer surface 302 of the composite structure 300. The tertiary attachment element 712c is arranged on the tertiary elongated base element 708, such as to be positioned between the tertiary elongated base element 708 and the outer surface 302 of the composite structure 300. The quaternary attachment element 712d is arranged on the quaternary elongated base element 710, such as to be positioned between the quaternary elongated base element 710 and the outer surface 302 of the composite structure 300. It should be understood that the attachment elements may be subdivided into a plurality of attachment elements, e.g. the guiding device 700 may comprise a plurality of primary attachment elements 712a to be positioned between the primary elongated base element 704 and the outer surface 302 of the composite structure 300, and/or the guiding device 700 may comprise a plurality of secondary attachment elements 712b to be positioned between the secondary elongated base element 706 and the outer surface 302 of the composite structure 300, and/or the guiding device 700 may comprise a plurality of tertiary attachment elements 712c to be positioned between the tertiary elongated base element 708 and the outer surface 302 of the composite structure 300, and/or the guiding device 700 may comprise a plurality of quaternary attachment elements 712d to be positioned between the quaternary elongated base element 710 and the outer surface 302 of the composite structure 300.

The guiding device 700 comprises one or more displacement bars, which may be curvilinear bars adapted to substantially follow a curvature of the surface area 304 of the composite structure 300. In the present example, the guiding device 700 comprises a primary displacement bar 720 and a secondary displacement bar 722. As illustrated, the primary displacement bar 720 and the secondary displacement bar 722 may be parallel. The displacement bars 720, 722 are movably attached to the primary elongated base element 704. For example, the displacement bars 720, 722 are movable along the primary elongated base element 704. As illustrated in FIG. 13B, the displacement bars 720, 722 may be movably attached to the secondary elongated base element 706 as well. The displacement bars 720, 722 are arranged substantially perpendicular to the primary elongated base element 704. The displacement bars 720, 722 extend between the primary elongated base element 704 and the secondary elongated base element 706. In an alternative embodiment, as illustrated in FIG. 13C, the secondary elongated base element 706 is omitted and instead the displacement bars 720, 722, opposite their first end 724 movably attached to the primary elongated base element 704, may be adapted to contact and being slidable over the outer surface 302 of the composite structure 300. For example, the displacement bars 720, 722 may comprise a wheel 728 arranged at the second end 726 opposite the first end 724, adapted to contact the outer surface 302 of the composite structure 300.

The guiding device 700 comprises a support element 714 movably attached to the displacement bars 720, 722. For example, the support element 714 may be movable along the displacement bars 720, 722. Thereby, the support element 714 is displaceable along the longitudinal direction L and perpendicular to the longitudinal direction relative to the primary elongated base element 704. The support element 714 is adapted to be fitted with a tool for inspecting and/or processing the surface area 304 of the composite structure 300. The support element 714 may, as illustrated in FIG. 13B, be arranged between the primary elongated base element 704 and the secondary elongated base element 706. The support element 714 is arranged between the tertiary elongated base element 708 and the quaternary elongated base element 710. The support element 714 is arranged between the primary displacement bar 720 and the secondary displacement bar 722.

The guiding device 700 may be attached to the outer surface 302 of the composite structure 300, as illustrated, in order to inspect and/or process part of the surface area 304 of the composite structure. To achieve a precise position of the tool on the composite structure 300, the guiding device 700 may advantageously be attached to the composite structure 300 in accordance with known datum points, such as datum points provided by the assistance tool 500, as described in relation to previous figures. By using the disclosed guiding device 700 to inspect and/or process the surface area 304, by being attached to the composite structure 300 at a well-established position distant from the surface area 304, local imperfections within the surface area 304 have less or no influence on the measurement or processing of the surface area 304 itself. This may be of particular importance when inspecting and/or processing a leading edge of a wind turbine blade, which may be prone to many local variations influencing the aerodynamic properties of the wind turbine blade.

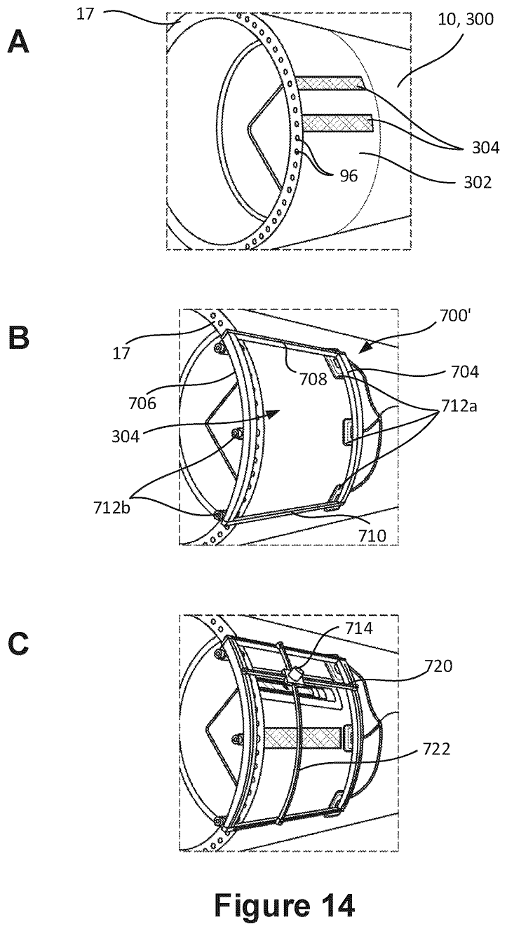

FIGS. 14A-14C schematically illustrate another exemplary guiding device 700′, which conceptually corresponds to the guiding device 700 of FIGS. 13A-13C, but whereas the guiding device 700 of FIGS. 13A-13C is adapted to inspect and/or process a surface area near the leading edge of a wind turbine blade, the guiding device 700′ of FIGS. 14A-14C is adapted to inspect and/or process a different surface area 304 of the same or a different composite structure 300. For example, as illustrated, the guiding device 700′ of FIGS. 14A-14C is adapted to inspect and/or process a surface area 304 near the root end 17 of a wind turbine blade 10. For example, the surface area 304 to be inspected and/or processed may be a surface area of bushings 96 for fastening the wind turbine blade 10 to the hub of the wind turbine.

FIG. 14A illustrates the surface area 304 of the outer surface 302 of the composite structure 300 to be inspected and/or processed. Particularly, the surface area 304 to be inspected and/or processed, as illustrated, corresponds to bushings 96 for fastening the wind turbine blade 10 to the hub of the wind turbine.

FIG. 14B illustrates the elongated base elements 704, 706, 708, 710 of the guiding device 700′ having been attached to the outer surface 302 of the composite structure 300.

As illustrated, the guiding device 700′ comprises a plurality of primary attachment elements 712a arranged on the primary elongated base element 704 and positioned between the primary elongated base element 704 and the outer surface 302 of the composite structure 300. The primary attachment elements 712a comprise vacuum elements adapted to adhere to the outer surface 302 by application of a negative pressure.

Also, the guiding device 700′ comprises a plurality of secondary attachment elements 712b arranged on the secondary elongated base element 706. The secondary elongated base elements are in the illustrated example provided to engage with bushings 96 of the root end 17. For a wind turbine blade 10, the positions of the bushings 96 are well-established and may serve as datum points for precise and well-established positioning of the guiding device 700′ relative to the wind turbine blade 10.

FIG. 14C illustrates the displacement bars 720, 722 and the support element 714 fitted with an instrument for processing and/or inspecting the surface area 302, being attached to the elongated base elements 704, 706, 708, 710.

The primary displacement bar 720 is attached to and extends between the primary elongated base element 704 and the secondary elongated base element 706. The primary displacement bar 720 extends perpendicular to the primary elongated base element 704 and the secondary elongated base element 706.

The secondary displacement bar 722 is attached to and extends between the tertiary elongated base element 708 and the quaternary elongated base element 710. The secondary displacement bar 722 extends perpendicular to the tertiary elongated base element 708 and the quaternary elongated base element 706. The secondary displacement bar 722 extends parallel to the primary elongated base element 704 and the secondary elongated base element 706. The secondary displacement bar 722 extends perpendicular to the primary displacement bar 720.

The support element 714 is arranged at the interface between the primary displacement bar 720 and the secondary displacement bar 722.

The support element 714 is displaceable along the longitudinal direction and perpendicular to the longitudinal direction relative to the primary elongated base element 704, by being movable along and together with the displacement bars 720, 722.

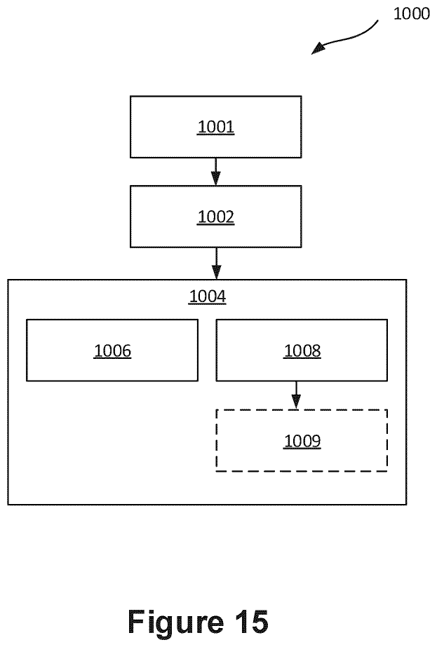

FIG. 15 is a flow-chart of a method 1000 for post mould processing of a composite structure. The method 1000 comprises providing an assistance tool 1001, such as an assistance tool as described in relation to FIGS. 8-9. The method further comprises arranging the assistance tool 1002 such that the first mating part of the composite structure and the second mating part of the assistance tool are fitted to each other. The method further comprises moving 1004 the assistance tool along the flange section.

While moving 1004 the assistance tool, the method may then also comprise operating 1006 a cutting element to separate the flange section from the main composite part along a cutting path.

Alternatively or additionally, the method may comprise, while moving 1004 the assistance tool, marking 1008 one or more datum points on the main composite part with a datum point marker at a pre-determined distance from respective one or more datum points on the flange section or on another part of the composite structure. The pre-determined distance may be a constant distance. However, in some embodiments, the pre-determined distance is varying with the position of the assistance tool along the longitudinal direction relative to the composite structure. Thus, the method may further comprise varying 1009 the pre-determined distance, while moving 1004 the assistance tool along the flange section.

By removing the flange section (by operating the cutting element 1006), simultaneously with transferring 1008 datum points, different post mould processing steps are combined in an improved streamlined and precise method.

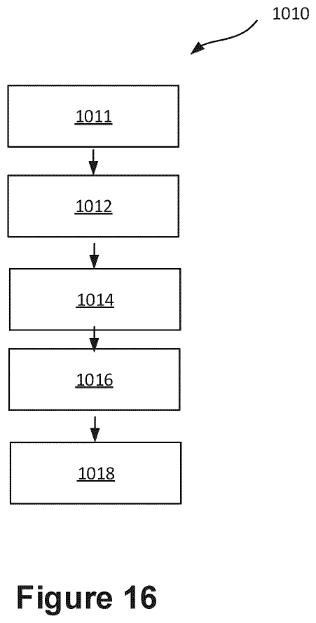

FIG. 16 is a flow-chart of a method 1010 for post mould processing of a composite structure. The method 1010 comprises providing 1011 a guiding device, such as a guiding device as described in relation to FIGS. 13A-13C. The method further comprises attaching 1012 the guiding device according to the outer surface of the composite structure. The method 1010 further comprises fitting 1014 a support element of the guiding device with a tool for inspecting and/or processing a surface area of the composite structure, moving 1016 the support element to be above the surface area, and inspecting and/or processing 1018 the surface area with the tool.

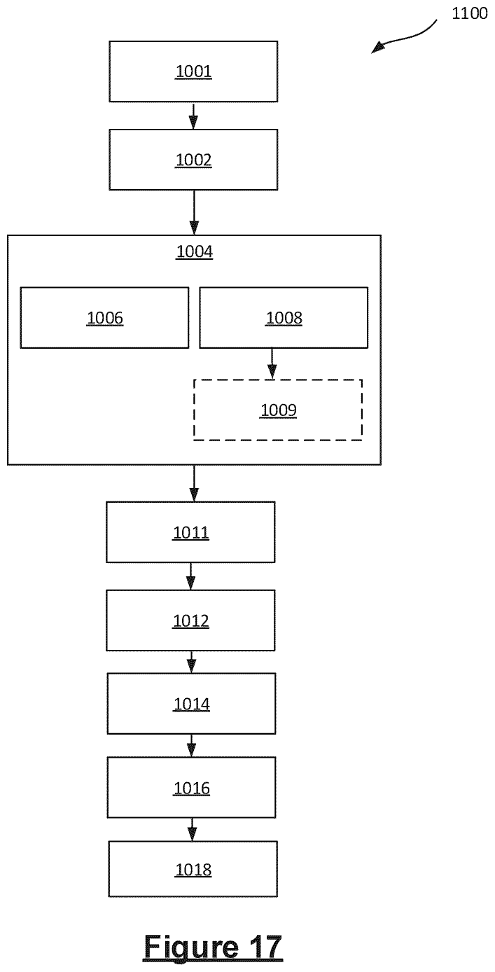

FIG. 17 illustrates a flow-chart of a method 1100 for post mould processing of a composite structure. The method 1100 combines the method 1000 of FIG. 15 and the method 1010 of FIG. 16. Hence, the method 1100 comprises providing an assistance tool 1001, such as an assistance tool as described in relation to FIGS. 8-9. The method 1100 further comprises arranging the assistance tool 1002 such that the first mating part of the composite structure and the second mating part of the assistance tool are fitted to each other. The method 1100 further comprises moving 1004 the assistance tool along the flange section.

While moving 1004 the assistance tool, the method 1100 may then also comprise operating 1006 a cutting element to separate the flange section from the main composite part along a cutting path. The method 1100 may comprise, while moving 1004 the assistance tool, marking 1008 one or more datum points on the main composite part with a datum point marker at a pre-determined distance from respective one or more datum points on the flange section or on another part of the composite structure.

Furthermore, the method 1100 comprises providing 1011 a guiding device, such as the guiding device as described in relation to FIGS. 13A-13C. The method 1100 further comprises attaching 1012 the guiding device according to the outer surface of the composite structure.

The step of attaching 1012 the guiding device is improved by the transfer and marking 1008 of datum points by the assistance tool and by aligning the guiding device relative to the transferred datum points. For example, the guiding device may be attached 1012 to the outer surface of the composite structure by aligning the one or more elongated base elements of the guiding device with the one or more datum points on the main composite part.

The method 1100 further comprises fitting 1014 a support element of the guiding device with a tool for inspecting and/or processing a surface area of the composite structure, moving 1016 the support element to be above the surface area, and inspecting and/or processing 1018 the surface area with the tool.

Preferably, the composite structure is a wind turbine blade and the surface area to be inspected or processed includes a part of a leading edge of the wind turbine blade. In some embodiments, the specified datum points are positioned more than a first distance from the leading edge of the composite structure. In some embodiments, the surface area of the composite structure is more than a first distance from the one or more datum points on the main composite part.

The invention has been described with reference to a preferred embodiment. However, the scope of the invention is not limited to the illustrated embodiment, and alterations and modifications can be carried out without deviating from the scope of the invention.

Throughout the description, the use of the terms “first”, “second”, “third”, “fourth”, “primary”, “secondary”, “tertiary” etc. does not imply any particular order or importance but are included to identify individual elements. Furthermore, the labelling of a first element does not imply the presence of a second element and vice versa.

### EXEMPLARY EMBODIMENTS OF THE PRESENT DISCLOSURE

1. An assistance tool for assisting in tasks performed at a composite structure, the composite structure extending along a longitudinal direction and comprising a main composite part, and a flange section extending around a perimeter of the main composite part, the flange section comprising an upper surface having a first mating part with a specific shape in a cross sectional plane perpendicular to the longitudinal direction, the first mating part being located at a fixed position relative to the main composite part,
the assistance tool comprising
   a body having a bottom surface defining a second mating part shaped and dimensioned to fit with the specific shape of the first mating part of the flange section, such that when the assistance tool is arranged on the flange section and the second mating part is fitted with the first mating part, the body of the assistance tool can be moved along the flange section, at a pre-determined distance from the main composite part.
2. The assistance tool according to item 1, wherein the assistance tool comprises a cutting element connected to the body and configured for cutting the composite structure along a cutting path defined between the main composite part and the flange section to separate the flange section from the main composite part.
3. The assistance tool according to item 1 or 2, wherein the second mating part in the cross-sectional plane comprises a second substantially linear section extending in a first direction, a second primary mating section extending from the second substantially linear section in a direction which is different from the first direction, and optionally a second end section extending from the second primary mating section.
4. The assistance tool according to item 3, wherein the second primary mating section is a slope or a curve or a linear section extending with an angle between 10-170 degrees from the second substantially linear section.
5. The assistance tool according to any of the preceding items, wherein the cutting element is a circular saw.
6. The assistance tool according to any of the preceding items, wherein the position of the cutting element relative to the body is adjustable, such that the cutting element can be moved between a first position and a second position.
7. The assistance tool according to item 6, wherein the body comprises a track allowing the cutting element to move relative to the body, the track defining the first and second position.
8. The assistance tool according to any of items 6 or 7, wherein
when the cutting element is arranged in the first position, the cutting element is arranged above the bottom surface of the body,
when the cutting element is in a second position, at least part of the cutting element is arranged below the lower surface of the body.
9. The assistance tool according to any of the preceding items, wherein the assistance tool is configured to be manually operated, by applying a force to the assistance tool in a direction towards the first mating part, while moving the body of the assistance tool along the flange section with the second mating part fitted with the first mating part.
10. The assistance tool according to any of the preceding items, wherein the assistance tool comprises an operating handle connected to the body and configured to facilitate manual operation of the assistance tool.
11. The assistance tool according to any of the preceding items, wherein at least part of the bottom surface of the body comprises a low-friction material allowing it to be moved with low friction along the flange section.
12. The assistance tool according to any of the preceding items, wherein the composite structure is a wind turbine blade and the main composite part is an airfoil of the wind turbine blade.
13. The assistance tool according to any of the preceding items, wherein the first mating part of the flange section in the cross-sectional plane perpendicular to the longitudinal direction comprises a first substantially linear section extending from the main composite part in a first direction, a first primary mating section extending from the first substantially linear section in a direction which is different from the first direction, and optionally a first end section extending from the first primary mating section in the first direction.
14. The assistance tool according to any of the preceding items, wherein the assistance tool comprises a datum point indicator connected to the body at a reference point and configured for marking one or more datum points on the main composite part relative to a datum point on the flange section of the composite structure when the assistance tool is moved along the flange section.
15. The assistance tool according to item 14, wherein the datum point indicator is an elongated element being attached at a first end to the reference point and having a datum point marker at a second end, opposite the first end.
16. The assistance tool according to item 14 or 15, wherein the datum point marker is a flexible liner and/or a liner adjustable in at least one length direction.
17. The assistance tool according to any of items 15-16, wherein the elongated element comprises telescopic cylinders and the datum point marker at an outermost cylinder of the telescopic cylinders, wherein the telescopic cylinders can be moved in and out of each other to adjust the position of the datum point marker relative to the reference point.
18. a System Comprising
a composite structure extending along a longitudinal direction and comprising
   a main composite part and
   a flange section extending around a perimeter of the main composite part, the flange section comprising an upper surface having a first mating part with a specific shape in a cross-sectional plane perpendicular to the longitudinal direction, the first mating part being located at a fixed position relative to the main composite part,
the assistance tool according to any of the preceding items.
19. The system according to item 18, wherein the composite structure is a wind turbine blade, the main composite part is an airfoil of the wind turbine blade, and the flange section extends from the main composite part along a leading edge and/or a trailing edge of the airfoil.
20. The system according to any of items 18 or 19, wherein the first mating part of the flange section in the cross sectional plane perpendicular to the longitudinal direction comprises a first substantially linear section extending from the main composite part in a first direction, a first primary mating section extending from the first substantially linear section in a direction which is different from the first direction, and optionally a first end section extending from the first primary mating section in the first direction.
21. Method for separating a flange section from a composite structure, wherein the composite structure extends along a longitudinal direction and comprising a main composite part, and the flange section extends around a perimeter of the main composite part, the flange section comprising an upper surface having a first mating part with a specific shape in a cross-sectional plane perpendicular to the longitudinal direction, the first mating part being located at a fixed position relative to the main composite part, and a cutting path being defined between the main composite part and the flange section, the method comprising the steps of:
providing an assistance tool according to any of items 2-17,
arranging the assistance tool such that the first mating part of the composite structure and the second mating part of the assistance tool are fitted to each other, and
moving the assistance tool along the flange section while operating the cutting element, to separate the flange section from the main composite part along the cutting path.
22. Method according to item 21, the method further comprising the step of: while moving the assistance tool along the flange section, marking one or more datum points on the main composite part with the datum point marker at a pre-determined distance from a datum point on the flange section.
23. Method for transferring one or more datum points on a composite structure, wherein the composite structure extends along a longitudinal direction and comprising a main composite part, and the flange section extends around a perimeter of the main composite part, the flange section comprising an upper surface having a first mating part with a specific shape in a cross-sectional plane perpendicular to the longitudinal direction, the first mating part being located at a fixed position relative to the main composite part, the method comprising:
providing an assistance tool according to any of items 14-17,
arranging the assistance tool such that the first mating part of the composite structure and the second mating part of the assistance tool are fitted to each other, and
moving the assistance tool along the flange section while marking one or more datum points on the main composite part with the datum point marker at a pre-determined distance from respective one or more datum points on the flange section.
24. Method according to any of items 21-23, wherein the pre-determined distance is a constant distance.
25. Method according to item 23, wherein the pre-determined distance is varying with the position of the assistance tool along the longitudinal direction relative to the composite structure.
26. Method according to any of items 21-25, wherein the composite structure is a wind turbine blade, the main composite part is an airfoil of the wind turbine blade, and the flange section extends from the main composite part along a leading edge and/or a trailing edge of the airfoil.
27. A guiding device for inspection and/or processing of a surface area of an outer surface of a composite structure, the composite structure extending along a longitudinal direction, the guiding device comprising:
one or more elongated base elements including a primary elongated base element adapted to be arranged on the outer surface of the composite structure,
one or more attachment elements for detachably attaching the one or more elongated base elements to the composite structure,
one or more displacement bars including a primary displacement bar and optionally a secondary displacement bar, the primary displacement bar being movably attached to the primary elongated base element,
a support element movably attached to the one or more displacement bars and displaceable along the longitudinal direction and perpendicular to the longitudinal direction relative to the primary elongated base element, the support element being adapted to be fitted with a tool for inspecting and/or processing the surface area of the composite structure.
28. Guiding device according to item 27, wherein the one or more elongated base elements include a secondary elongated base element, and wherein the primary displacement bar is movably attached to the secondary elongated base element, the primary displacement bar extending between the primary elongated base element and the secondary elongated base element, and the support element being arranged between the primary elongated base element and the secondary elongated base element.
29. Guiding device according to any of items 27-28, wherein the primary elongated base element and/or the secondary elongated base element are adapted to be arranged parallel to the longitudinal direction of the composite structure.
30. Guiding device according to any of items 27-29, wherein the primary elongated base element and/or the secondary elongated base element are adapted to be arranged perpendicular to the longitudinal direction of the composite structure.
31. Guiding device according to any of items 27-30, wherein the one or more elongated base elements include a tertiary elongated base element and optionally a quaternary elongated base element, the tertiary elongated base element and optionally the quaternary elongated base element being arranged substantially perpendicular to the primary elongated base element.
32. Guiding device according to item 31 as dependent on at least item 28, wherein the tertiary elongated base element and optionally the quaternary elongated base element extend between the primary elongated base element and the secondary elongated base element.
33. Guiding device according to any of items 31-32, wherein the one or more elongated base elements include the quaternary elongated base element, and wherein the support element is arranged between the tertiary elongated base element and the quaternary elongated base element.
34. Guiding device according to any of items 27-33, wherein the primary displacement bar is arranged substantially perpendicular to the primary elongated base element.
35. Guiding device according to any of items 27-34, wherein the primary displacement bar is movable along the primary elongated base element.
36. Guiding device according to any of items 27-35, wherein the support element is movable along the one or more displacement bars.
37. Guiding device according to any of items 27-36, wherein the one or more displacement bars are curvilinear bars adapted to substantially follow a curvature of the surface area of the composite structure.
38. Guiding device according to any of items 27-37, wherein the one or more displacement bars include the secondary displacement bar, and wherein the support element is arranged between the primary displacement bar and the secondary displacement bar.
39. Guiding device according to any of items 27-38, wherein the primary displacement bar comprises a first end movably attached to the primary elongated base element and an opposite second end adapted to contact and being slidable over the outer surface of the composite structure.
40. Guiding device according to item 39, wherein the primary displacement bar comprises a wheel arranged at the second end adapted to contact the outer surface of the composite structure.
41. Guiding device according to any of items 27-40, wherein each of the one or more attachment elements comprises a vacuum element with a fluid outlet adapted to be connected to a vacuum source, the vacuum element being adapted to adhere to the outer surface of the composite structure by application of a negative pressure by the vacuum source.
42. Guiding device according to any of items 27-41, wherein a primary attachment element of the one or more attachment elements are arranged on the primary elongated base element, such as to be positioned between the primary elongated base element and the outer surface of the composite structure.
43. Guiding device according to any of items 27-42, wherein a tertiary attachment element of the one or more attachment elements are arranged on the tertiary elongated base element, such as to be positioned between the tertiary elongated base element and the outer surface of the composite structure.
44. A method for inspection and/or processing of a surface area of an outer surface of a composite structure, the composite structure extending along a longitudinal direction, the method comprising:
attaching the guiding device according to any of items 27-43 to the outer surface of the composite structure,
fitting the support element with a tool for inspecting and/or processing the surface area of the composite structure,
moving the support element to be over the surface area,
inspecting and/or processing the surface area with the tool.
45. Method according to item 44, wherein attaching the guiding device includes aligning the one or more elongated base elements of the guiding device with one or more datum points of the outer surface of the composite structure.
46. Method according to item 45, wherein the one or more datum points are located outside the surface area of the composite structure.
47. Method according to any of items 44-46, wherein the composite structure is a wind turbine blade comprising a leading edge.
48. Method according to item 47, wherein the one or more datum points are positioned more than a first distance from the leading edge of the wind turbine blade
49. Method according to any of items 47 or 48, wherein the surface area includes a part of the leading edge of the wind turbine blade.
50. A method for post mould processing of a composite structure, wherein the composite structure extends along a longitudinal direction and comprising a main composite part, and a flange section extending around a perimeter of the main composite part, the flange section comprising an upper surface having a first mating part with a specific shape in a cross-sectional plane perpendicular to the longitudinal direction, the first mating part being located at a fixed position relative to the main composite part, the method comprising:
providing an assistance tool according to any of items 14-17,
arranging the assistance tool such that the first mating part of the composite structure and the second mating part of the assistance tool are fitted to each other,
moving the assistance tool along the flange section while marking one or more datum points on the main composite part with the datum point marker at a pre-determined distance from respective one or more datum points on the flange section,
providing a guiding device according to any of items 27-43,
attaching the guiding device to the outer surface of the composite structure aligning the one or more elongated base elements of the guiding device with the one or more datum points on the main composite part,
fitting the support element with a tool for inspecting and/or processing a surface area of the composite structure,
moving the support element to be above the surface area,
inspecting and/or processing the surface area with the tool.
51. Method according to item 50, wherein the surface area of the composite structure is more than a first distance from the one or more datum points on the main composite part.
52. Method according to any of items 50-51, wherein the composite structure is a wind turbine blade comprising a leading edge.
53. Method according to item 52, wherein the specified datum points are positioned more than a first distance from the leading edge of the composite structure.
54. Method according to any of items 52 or 53, wherein the surface area includes a part of the leading edge of the wind turbine blade.
55. Method according to any of items 50-54, wherein the assistance tool further comprises a cutting element connected to the body and configured for cutting the composite structure along a cutting path defined between the main composite part and the flange section to separate the flange section from the main composite part, and the method comprising operating the cutting element to separate the flange section from the main composite part along the cutting path while moving the assistance tool along the flange section.
56. Method according to any of items 50-55, wherein the pre-determined distance is a constant distance.
57. Method according to any of items 50-55, wherein the pre-determined distance is varying with the position of the assistance tool along the longitudinal direction relative to the composite structure.

### LIST OF REFERENCES

2 wind turbine
4 tower
6 nacelle
8 hub
10 blade
14 blade tip
15 tip end
16 blade root
17 root end
18 leading edge
20 trailing edge
24 first blade shell part (pressure side)
26 second blade shell part (suction side)
28 bond lines/glue joints
30 root region
32 transition region
34 airfoil region
34a first airfoil region
34b second airfoil region
36 first shell part flange
38 second shell part flange
40 shoulder
42 shear web or spar side
74 first spar cap
76 second spar cap
78 mould system
80 first mould
84 first moulding surface
90 second mould
94 second moulding surface
96 bushings
300 composite structure
302 outer surface
304 surface area
306 main composite part
308 flange section
309 pre-determined distance
310 cutting path
314 first mating part
316 first substantially linear section
318 first primary mating section
320 first end section
322 datum point on flange section
324 datum point on composite structure
500 assistance tool
502 body
504 cutting element
506 reference point
510 first end
512 second end
514 datum point indicator
515 datum point marker
516 second mating part
518 second substantially linear section
520 second primary mating section
522 second end section
524 track
526 operating handle
700 guiding device
704 primary elongated base element
706 secondary elongated base element
708 tertiary elongated base element
710 quaternary elongated base element
712a-712d attachment elements
714 support element
716 tool (for inspecting and/or processing surface area)
720 primary displacement bar
722 secondary displacement bar
724 first end
726 second end
728 wheel
730 vacuum element
732 fluid outlet
1000 method
1001 providing assistance tool
1002 arranging the assistance tool
1004 moving the assistance tool
1006 operating the cutting element
1008 marking one or more datum points
1009 varying pre-determined distance
1010 method
1011 providing a guiding device
1012 attaching the guiding device
1014 fitting a support element of the guiding device with a tool
1016 moving the support element to be over surface area
1018 inspecting and/or processing the surface area with the tool
L longitudinal direction

1. An assistance tool for assisting in tasks performed at a composite structure, the composite structure extending along a longitudinal direction and comprising a main composite part, and a flange section extending around a perimeter of the main composite part, the flange section comprising an upper surface having a first mating part with a specific shape in a cross sectional plane perpendicular to the longitudinal direction, the first mating part being located at a fixed position relative to the main composite part, the assistance tool comprising:
a body having a bottom surface defining a second mating part configured to fit with the specific shape of the first mating part of the flange section, such that, when the assistance tool is arranged on the flange section and the second mating part is fitted with the first mating part, the body of the assistance tool can be moved along the flange section at a pre-determined distance from the main composite part.

2. The assistance tool of claim 1, wherein the assistance tool further comprises a cutting element connected to the body and configured for cutting the composite structure along a cutting path defined between the main composite part and the flange section to separate the flange section from the main composite part.

3. The assistance tool of claim 2, wherein the cutting element is a circular saw.

4. The assistance tool of claim 2, wherein a position of the cutting element relative to the body is adjustable, such that the cutting element can be moved between a first position and a second position, wherein
when the cutting element is arranged in the first position, the cutting element is arranged above the bottom surface of the body, and
when the cutting element is in a second position, at least part of the cutting element is arranged below the lower surface of the body.

5. The assistance tool of claim 4, wherein the body comprises a track allowing the cutting element to move relative to the body, the track defining the first and second position.

6. The assistance tool of claim 1, wherein the assistance tool is configured to be manually operated, by applying a force to the assistance tool in a direction towards the first mating part, while moving the body of the assistance tool along the flange section with the second mating part fitted with the first mating part.

7. The assistance tool of claim 6, wherein the assistance tool comprises an operating handle connected to the body and configured to facilitate manual operation of the assistance tool.

8. The assistance tool of claim 1, wherein the composite structure is a wind turbine blade and the main composite part is an airfoil of the wind turbine blade.

9. The assistance tool of claim 1, wherein the first mating part of the flange section in the cross-sectional plane perpendicular to the longitudinal direction comprises:
a first linear section extending from the main composite part in a first direction; and
a first primary mating section extending from the first linear section in a direction which is different from the first direction.

10. The assistance tool of claim 9, wherein the second mating part in the cross-sectional plane comprises:
a second linear section extending in the first direction; and
a second primary mating section extending from the second linear section in the direction which is different from the first direction.

11. The assistance tool of claim 1, wherein the assistance tool further comprises a datum point indicator connected to the body at a reference point and configured for marking one or more datum points on the main composite part relative to a datum point on the flange section of the composite structure when the assistance tool is moved along the flange section.

12. The assistance tool of claim 11, wherein the datum point indicator is an elongated element being attached at a first end to the reference point and having a datum point marker at a second end, opposite the first end.

13. The assistance tool of claim 12, wherein the datum point marker is a flexible liner configured to be arranged along a curvature of the main composite part.

14. The assistance tool of claim 12, wherein the elongated element comprises telescopic cylinders and the datum point marker at an outermost cylinder of the telescopic cylinders, wherein the telescopic cylinders can be moved in and out of each other to adjust the position of the datum point marker relative to the reference point.

15. A system comprising:
a wind turbine blade extending along a longitudinal direction and comprising:
an airfoil part; and
a flange section extending around a perimeter of the airfoil, the flange section comprising an upper surface having a first mating part with a specific shape in a cross-sectional plane perpendicular to the longitudinal direction, the first mating part being located at a fixed position relative to the airfoil; and
an assistance tool comprising:
a body having a bottom surface defining a second mating part shaped and dimensioned to fit with the specific shape of the first mating part of the flange section, such that, when the assistance tool is arranged on the flange section and the second mating part is fitted with the first mating part, the body of the assistance tool can be moved along the flange section at a pre-determined distance from the airfoil.

16. The system of claim 15, wherein the assistance tool further comprises a cutting element connected to the body and configured for cutting the wind turbine blade along a cutting path defined between the airfoil and the flange section to separate the flange section from the airfoil.

17. The system of claim 15, wherein the assistance tool further comprises a datum point indicator connected to the body at a reference point and configured for marking one or more datum points on the airfoil relative to a datum point on the flange section of the wind turbine blade when the assistance tool is moved along the flange section.

18. A method for separating a flange section from a composite structure, wherein the composite structure extends along a longitudinal direction and comprising a main composite part, and the flange section extends around a perimeter of the main composite part, the flange section comprising an upper surface having a first mating part with a specific shape in a cross-sectional plane perpendicular to the longitudinal direction, the first mating part being located at a fixed position relative to the main composite part, and a cutting path being defined between the main composite part and the flange section, the method comprising:
providing an assistance tool, wherein the assistance tools comprises a body having a bottom surface defining a second mating part shaped and dimensioned to fit with the specific shape of the first mating part of the flange section, such that, when the assistance tool is arranged on the flange section and the second mating part is fitted with the first mating part, the body of the assistance tool can be moved along the flange section at a pre-determined distance from the main composite part and a cutting element connected to the body and configured for cutting the composite structure along a cutting path defined between the main composite part and the flange section;
arranging the assistance tool such that the first mating part of the composite structure and the second mating part of the assistance tool are fitted to each other; and
moving the assistance tool along the flange section while operating the cutting element to separate the flange section from the main composite part along the cutting path.

19. The method of claim 18, the method further comprising, while moving the assistance tool along the flange section, marking one or more datum points on the main composite part with the datum point marker at a pre-determined distance from a datum point on the flange section.

20. The method of claim 18, wherein the composite structure is a wind turbine blade and the main composite part is an airfoil of the wind turbine blade.
